(19) United States
(12) Patent Application Publication
(10) Pub. No.: US 2023/0347978 A1
(43) Pub. Date: Nov. 2, 2023

(54) Rotary Position Sensor

(71) Applicant: Methode Electronics Malta Ltd., Birkirkara (MT)

(72) Inventors: Allen Carl Bonnici Micallef, Mosta (MT); Alexander Galea, Dingli (MT); Matthew Spiteri, Zejtun (MT)

(21) Appl. No.: 18/138,174

(22) Filed: Apr. 24, 2023

(30) Foreign Application Priority Data
Apr. 29, 2022 (DE) 102022001510.2

(51) Int. Cl. B62D 15/02

(52) U.S. Cl. CPC B62D 15/0215

(57) ABSTRACT

A rotary position sensor to determine a position of a rotary system comprising at least three individual position sensors (10, 11, 12) and a gear box (13). A target (9) that is related to the rotary system is scanned by the individual position sensor (10, 11, 12). The first individual position sensor (10) determines a position of the rotary system. The second individual position sensor (11) determines an angle of rotation referring to the rotary system. Wherein the third individual position sensor (12) measures a rotational change referring to the rotary system.

### RELATED APPLICATION DATA

This application claims priority benefit of German Patent Application Ser. No. DE 10 2022 001 510.2 filed Apr. 29, 2022, the disclosure of which is incorporated by reference herein.

### BACKGROUND AND SUMMARY

The invention relates to a rotary position sensor to determine a position of a rotary system.

The rotary position sensor comprises at least three individual position sensors. Also, the rotary position sensor provides a gear box.

A target that is related to the rotary system is scanned by the individual position sensor.

The first individual position sensor determines a position of the rotary system. Wherein the second individual position sensor determines an angle of rotation referring to the rotary system. The third individual position sensor measures a rotational change referring to the rotary system.

The WO 2021/140006 A1 reveals a rotary angle sensor for determining a rotary angle and/or a torque. The rotary angle sensor which is arranged for determining a rotary angle and/or a torque comprises a housing and a rotor. The rotor is arranged on the housing so as to be rotatable about a rotational axis. The rotor provides a rotor assembly with a rotor latching device. Latching elements are arranged to interact in such way that a securing ring is fixed in the axial direction along the rotational axis relative to the rotor. The axial position securing the latching elements interacts in such way that the rotor is fixed on the housing substantially without play in the axial direction along the rotational axis.

Rotary position sensors are commonly used in vehicles which are equipped with a by-wire steering. Rotary position sensors are also used with autonomous vehicles.

The rotary position sensor may be used in vehicles to achieve a precise measurement of the position of the steering mechanism of the vehicle. The steering mechanism comprises at least one of a steering column or a steering rack. The steering column and/or the steering rack may be driven e.g. by a ball screw mechanism and/or by a lead screw mechanism. It goes without saying that the steering mechanism comprises other components as well.

The rotary position sensor may be designed as an absolute rotary positions sensor. The absolute rotary position sensor determines the position of at least one component of the steering mechanism.

### OBJECT OF THE INVENTION

It is the object of the invention to provide a rotary position sensor which provides sufficient accuracy and a sufficient resolution in order to feedback information to the associated system. The feedback of information provides data to the system to achieve real time decisions and to achieve corrections of the steering angle.

### Rotary Position Sensor

As used herein, the term sensor mean a device which produces an output signal for the purpose of sensing a phenomenon.

In other words, the sensor is a device and/or a module and/or a subsystem which detects an event. It may also detect changes in the environment of the sensor. The sensor may also send information to connected electronic components.

A rotary position sensor is used to measure an angle of rotation of an object up to 360°.

The rotary position sensor may be an absolute rotary position sensor. The term absolute rotary position sensor means a sensor which gives information on its position within a given scale or range. The absolute rotary position sensor however, does not need a specific reference point.

In other words, the absolute rotary position sensor provides a static reference point.

The absolute rotary position sensor may be an optical sensor. It may also be a magnetic sensor or an Eddy current sensor.

It goes without saying that the absolute rotary position sensor can be any other type of sensor.

The absolute rotary position sensor is preferably used in situations where a speed accuracy and/or a position accuracy and/or a fail tolerance are absolute musts.

When the absolute rotary position sensor is used, the absolute position is determined by power-up. In other words, when the power is switched on (power-up) a reference mark is not required.

The absolute rotary position sensor offers an improved performance and/or a better precision at lower overall costs.

The absolute rotary position sensor may be used to determine the exact position of a rotary system.

The absolute rotary position sensor may be mounted on a steering wheel or a steering column of the steering mechanism of the vehicle.

### Rotary System

The rotary system may be a steering wheel or a steering column of the vehicle. The rotary system may also be a steering rack of steering mechanism of the vehicle.

It goes without saying that the rotary system may also be an input shaft of a component of the steering mechanism. Obviously, the rotary system may also be composed of other components of the steering mechanism of the vehicle.

The steering mechanism comprises a number of components which allows a vehicle to follow a desired course.

The rotary system performs a finite number of turns in the clockwise and/or in the anti-clockwise direction.

### Vehicle

As used herein, the term vehicle may be a land-based vehicle or an air-based vehicle. Of course, the vehicle can also be a water-based vehicle. In the following, the invention is described using a car.

In the present context, the term vehicle may also mean a vehicle which is driven by wire. The term vehicle may also include an autonomous vehicle.

In the modern automotive industry, the by-wire technology means the use of electrical and/or electronic-mechanical systems for performing vehicle functions which where traditionally achieved by mechanical linkages.

The autonomous vehicle is a vehicle that is capable of sensing its environment. The autonomous vehicle may move safely with little or no human input on a road. The autonomous vehicle combines a variety of different sensors to observe the surroundings of the vehicle.

### Sensor Target

The invention understands the term sensor target to mean an area of the object which is scanned by the sensor.

The first individual position sensor and/or the second individual position sensor and/or the third individual position sensor each generates a signal.

Using the example of the first individual position sensor, the target of the first individual position sensor may be defined as a distance at which a signal change of the signal which is produced by the first individual position sensor is generated.

The targets which the first individual position sensor and the second individual position sensor relate to respectively, are connected to a gear box. The gear box will be referred to in more detail below.

### Individual Position Sensors of the Rotary Position Sensor

According to the invention, the rotary position sensor comprises a cluster of at least three individual position sensors.

The cluster of individual position sensors means a group of sensors that act like one single sensor system. The cluster of the individual position sensors enables a higher availability of the sensors. The cluster of the individual position sensors provides a higher sensitivity as well as an improved variability of the sensors.

The respective output of the individual position sensor of the cluster of individual position sensors is used to determine an angular position and/or a turn number of the rotary system.

The rotary position sensor comprises at least three individual position sensors.

The output of the at least one individual position sensor is used to determine an angular position and/or a turn number of the associated rotary system.

The individual position sensor is a sensor which facilitates a measurement of a mechanical position. The individual position sensor also indicates the absolute position (location) and/or the relative position (displacement) of the rotary system.

The indication of the absolute position of the rotary system and/or the indication of the relative position of the rotary system is referred to in terms of a linear travel and/or in terms of a rotational angle and/or in terms of a three-dimensional space.

Of a variety of different types of individual position sensors, the individual position sensor may be a capacitive displacement sensor or an eddy-current sensor.

The individual position sensor may also be a hall effect sensor or an inductive sensor.

Alternatively, the individual position sensor may further be a position encoder such as an absolute encoder and/or an incremental encoder. The individual position sensor may alternatively be a linear encoder or a rotary encoder.

It goes without saying that other types of individual position sensors may be employed as well.

### First- and Second Individual Position Sensor

The first individual position sensor determines the rotational position of the target.

The determination of the absolute rotational position of the target depends on the position of the target relative to the first individual position sensor.

The first individual position sensor is used to determine an absolute position of the rotary system. W herein the absolute position of the rotary system is determined both by the number of turns and by the angle of rotation of the rotary system. As referred to above, the rotary system may preferably be the steering wheel or the steering column or the steering rack.

The first individual position sensor is required for the rotary position sensor to output the position of the rotary position when the power of the rotary position sensor is switched on.

The output of the first individual position sensor and/or output of the second individual position sensor and/or the output of the third individual position sensor is used for at least one algorithm. The at least one algorithm is provided to compute the position of the rotary system during the operation of the rotary system.

The first individual position sensor and/or the second individual position sensor and/or the third individual position sensor is arranged on a printed circuit board (PCB), respectively.

The first individual position sensor and/or the second individual position sensor and/or the third individual position sensor may be positioned and/or fixed in front of the associated target.

An absolute position of the rotary system refers to the turn number and to the angle of rotation of the rotary system, wherein the rotary system may be at least one of the steering wheel and/or the steering column and/or the steering rack.

It goes without saying that the rotary system may also be an input shaft of a component of the steering system.

The second individual position sensor is also capable of determining the rotational position of the target of the rotary system, to which the second individual position sensor relates, depending on the position of the respective target.

The second individual position sensor is employed to determine the angle of rotation of at least one of multiple turns of the rotary system.

The second individual position sensor determines the position and/or the direction of rotation of the respective rotary system.

The second individual position sensor is employed in order to improve the resolution of the rotary system.

Thus, the improvement of the resolution of the rotary system may also relate to the output of the second individual position sensor.

As referred to above, the target for the second individual position sensor is connected to the gear box.

The second individual position sensor is arranged on the printed circuit board (PCB).

The second individual position sensor is both positioned and fixed in front of the associated target of the second individual position sensor.

As referred to above, the second individual position sensor outputs the turn number and the corresponding angle of rotation of the rotary system at any point in time.

To output such data, the second individual position sensor is evaluated using a software algorithm.

### Third Individual Position Sensor

The third individual position sensor is able to detect at least one change referring to at least one rising edge and/or at least one falling edge of a toothed gear of the rotary system.

As referred to above, the rotary system may be a steering wheel or a steering column or a steering rack. It goes without saying that the rotary system may also be any other component of the steering mechanism.

According to the invention, the third individual position sensor is employed to measure a rotational change of the toothed gear of the gear at high acquisition speeds.

To distinguish the third individual position sensor from the first individual position sensor and/or from the second individual position sensor, the third individual position sensor does not determine a position and/or a direction of rotation of the rotary system.

The third individual position sensor is arranged on the printed circuit board (PCB).

Additionally, the third individual position sensor is positioned and/or fixed in front of the associated target.

The output of the third individual position sensor is also computed to another component by using a software algorithm.

The software algorithm is arranged to determine the rotary position of the input shaft of the rotary position sensor.

The output of the first individual position sensor and/or of the second individual position sensor and/or of the third individual position sensor, respectively, are computed using the software algorithm. The software algorithm is used to determine the rotary position of the rotary system. The rotary position of the rotary system comprises the turn number and/or the angle of rotation of the rotary system.

### Gear Box

The rotary position sensor provides a gear box. The gear box provides a number of gears.

The invention understands the term gear to mean a toothed cylindrical or roller shape component of a machine. In the following, the casing that houses the individual gears is referred to by the term gear box.

The gear inside the gear box mashes with another toothed cylindrical or roller shape component to transmit power from one shaft to another component.

The gears inside the gear box are preferably used to receive a different torque and speed ratio.

The gears inside the gear box may be used for changing the direction of the driving shaft and/or for changing the direction of the driven shaft.

Preferably, the gear box has at least three main functions.

One function of the gear box is to increase a torque from a driving component (e.g. motor) to a driven component.

It is another function of the gear box to reduce the speed generated by the motor.

Yet another function of the gear box is to change the direction of the driving shaft and/or to change the direction of the driven shaft.

The driving gear of the gear box is attached to a source of mechanical power. By way of example, the driving gear is powered by a shaft of an electric motor.

The driven gear of the gear box receives the mechanical power from (e.g.) the electric motor so that the driven machine can perform its function.

By way of example, if the driven gear of the gear box provides more teeth than the drive gear, there is a reduction in the output speed.

When the number of teeth on the driver gear of the gear box is larger than the number of teeth on the driven gear, the speed of the driven gear may be increased.

In the following, the gear box may be referred to as a complex split planetary gear box.

The planetary gear box comprises planetary gears. The planetary gears mash to the driver gear of the rotary position sensor and/or to a fixed ring gear of the rotary position sensor.

Additionally, the planetary gears of the gear box engage to at least two independent rotating ring gears.

The rotating ring gears provide different gearing ratios.

The gearing ratios allow one of the ring gears of the gear box to rotate only one revolution for a total number of finite revolutions of the input shaft. The other rotating ring gear rotates a number of times. However, the other rotating ring gear rotates less often than the input shaft.

In other words, the number of rotations of the other rotating ring gears of the gear box will be smaller than the number of rotation of the input shaft of the gear box.

Thus, the number of rotations depends on the accuracy requirements of the rotary system.

The rotating ring gears of the planetary gear box provide different gearing ratios. The different gearing ratios of the planetary gear box allow one of the ring gears of the planetary gear box to rotate only one revolution for the total number of finite revolutions of the input shaft of the rotary position sensor.

The toothed gear provided for the third individual position sensor is positioned on a drive gear of the planetary gear box.

The drive gear is connected to an input shaft, preferably with a ratio of 1:1.

### DESCRIPTION OF THE DRAWINGS

Further examples and advantageous embodiments of the invention are explained in more detail with reference to the drawings.

FIG. 1 shows a rotary position sensor in an exploded view,

FIG. 2 shows the rotary position sensor in a lateral section,

FIG. 3 shows a function block diagram of the rotary position sensor and

FIG. 4 shows a diagram representing the respective outputs of the individual position sensors.

### DETAILED DESCRIPTION

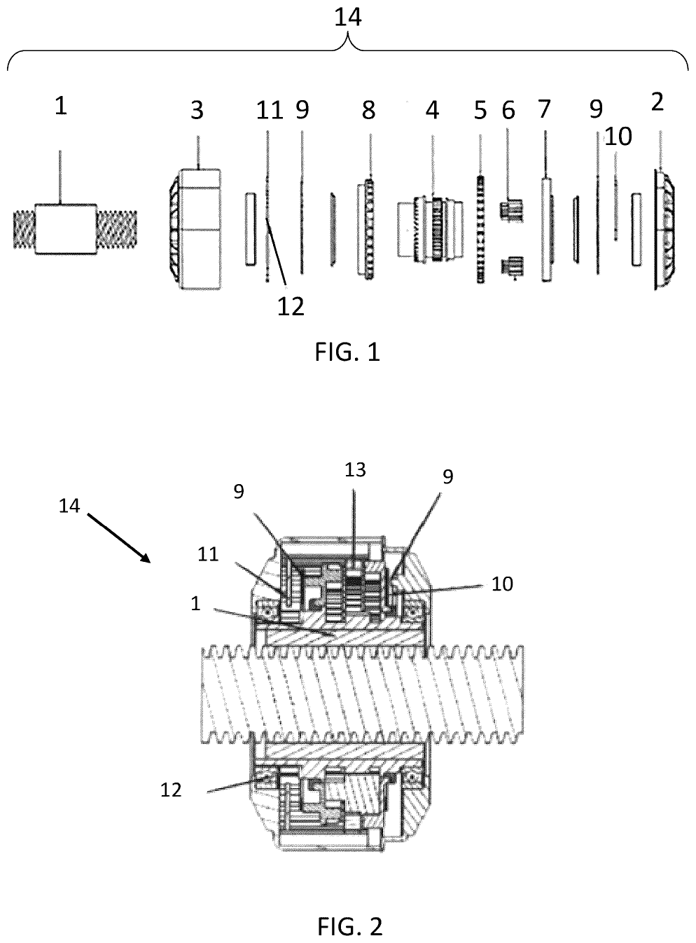

FIG. 1 shows a rotary position sensor 14 in an exploded view.

From left to right one can see an input shaft 1 of the rotary position sensor 14.

In the order from left to right, FIG. 1 further shows a first casing 3 working together with a second casing 2.

Next to the first casing 3, FIG. 1 shows the second individual position sensor 11, linked to which is the third individual position sensor 12.

A sensor target 9 is positioned adjacent to the second and the third individual position sensors 11, 12.

Right next to the sensor target 9 a rotating ring gear 8 is shown.

Between the rotating ring gear 8 and a fixed ring gear 5 a driver gear 4 is arranged.

To cooperate with the fixed ring gear 5, in FIG. 1 the planetary gears 6 are shown.

Another rotating ring gear 7 is positioned in the FIG. 1 between the planetary gear 6 and the sensor target 9.

The first individual position sensor 10 is arranged adjacent to the sensor target 9.

The FIG. 2 shows a sectional view of the rotary position sensor 14.

In a centre of the FIG. 2 the input shaft 1 of the rotary position sensor 14 is shown.

Both the first individual position sensor 10, the second individual position sensor 11 and the third individual position sensor 12 are arranged radially relative to the input shaft 1.

Two sensor targets 9 are shown in parallel to the second individual position sensor 11 and in parallel to the first individual position sensor 10.

Between the two sensor targets 9 the planetary gear box 13 is arranged.

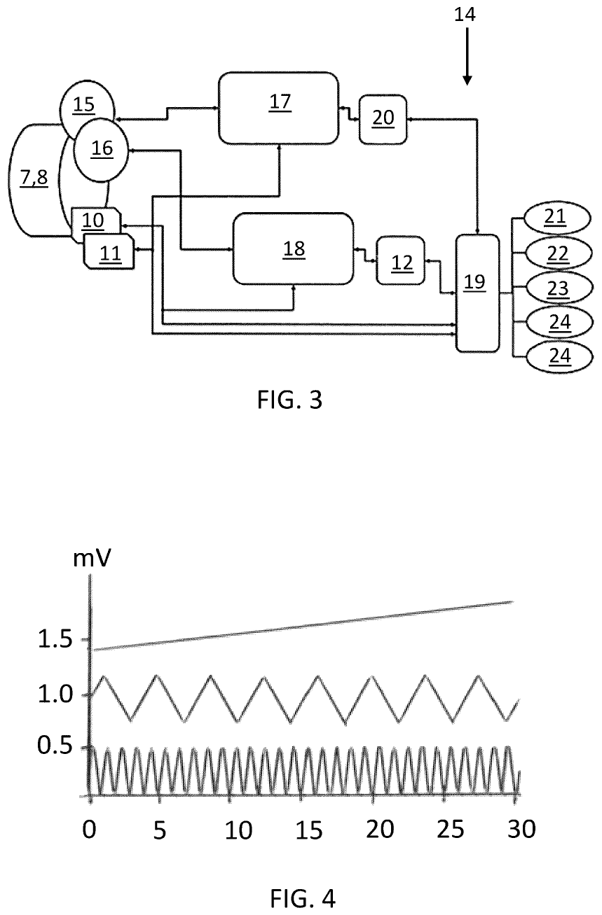

FIG. 3 shows a function block diagram of the rotary position sensor 14.

As an example, one of a plurality of rotating gears 7, 8 is shown in FIG. 3.

In FIG. 3, both the first individual position sensor 10 and the second individual position sensor 11 is shown, respectively.

The third individual position sensor is given the reference 12.

Two individual coils 15, 16 are shown, wherein one of the coils 15 communicates with a micro controller master 17.

The other coil 16 communicates with a micro controller slave 18. In the FIG. 3 a protection means 19 is arranged. The protection means 19 communicates with the micro controller slave 18 via the third individual position sensor 12.

The protection means 19 is connected to the micro controller master 17 via a communication link 20.

The protection means 19 is linked to a controller area network 21 (CAN).

The controller area network 21 may be designed as a serial network. The controller area network 21 (CAN) may preferably be used in an embedded system. The controller area network 21 may be a network which is established among other micro controllers.

The controller area network 21 (CAN) may be designed as a serial, two-wire differential bus technology.

Data may be send, one bit at a time, through at least two complimentary signals. The at least two complimentary signals may be sent on at least one controller area network high bus wire (CAN-H) and on at least one controller area network low (CAN-L) 22.

Every CAN application 21, 22 may consist of a micro controller with at least one built-in CAN controller and at least one transceiver which is tied to the bus.

The protection means 19 is also linked to a so called SENT-protocol 23 (single edge nibble transmission protocol).

The SENT-protocol 23 may be a point-to-point scheme for transmitting signal values from a sensor to a controller.

The SENT-protocol 23 is intended to allow for a transmission of high resolution data with a low system cost.

The protection means 19 may also be connected to at least one Pulse-width modulation (PWM) 24.

The Pulse-width modulation (PWM) 24 is designed as a method for reducing the average power which is delivered by an electrical signal.

The average power delivered by the electrical signal is effectively chopped into at least two discrete parts.

FIG. 4 shows a coordinate system with the number of turns of the rotary system displayed on the X-axis.

It is assumed that the Y-axis of the coordinate system shows the signal output of the first individual position sensor 10 and the signal output of the second individual position sensor 11 and the signal output of the third individual position sensor 12 in mV (Millivolt).

On the X-axis of the coordinate system, a number of 0 to 30 rotations and/or turns of the rotary system is shown.

The Y-axis of the coordinate system shows signal output values in mV of the first or of the second or of the third individual position sensor 10, 11, 12 between 0 mV and 15 mV.

In the coordinate system, the signal output curve of the first individual position sensor 10 is marked with the reference 25.

In the coordinate system, the signal output curve of the second individual position sensor 11 is designated with the reference 26.

The signal output curve of the third individual position sensor 12 carries the reference 27.

### REFERENCE LIST

1. input shaft
2. second casing
3. first casing
4. driver gear
5. fixed ring gear
6. planetary gear
7. rotating ring gear
8. rotating ring gear
9. sensor target
10. first individual position sensor
11. second individual position sensor
12. third individual position sensor
13. planetary gear box
14. rotary position sensor
15. coil
16. coil
17. micro controller master
18. micro controller slave
19. protection means
20. communication link
21. CAN
22. CAN-1
23. SENT
24. PWM
25. signal output curve of first individual position sensor
26. signal output curve of second individual position sensor
27. signal output curve of third individual position sensor

1. A rotary position sensor to determine a position of a rotary system, the rotary position sensor comprising:
at least three individual position sensors;
a gear box;
at least one target that is related to the rotary system;
wherein at least one of the at least three individual position sensors is adapted and configured to scan the at least one target, a first of the at least three individual position sensors is adapted and configured to determine a position of the rotary system, a second of the at least three individual position sensors is adapted and configured to determine an angle of rotation referring to the rotary system, and a third of the at least three individual position sensors is adapted and configured to measure a rotational change referring to the rotary system.

2. The rotary position sensor according to claim 1 characterized in that at least one of the first, the second and the third individual position sensor generates an output signal which is used for an algorithm to compute the position of the rotary system.

3. The rotary position sensor according to claim 1 characterized in that the gear box of the rotary position sensor is a planetary gear box comprising at least one of a driver gear, a fixed ring gear, a planetary gear, and at least one rotating ring gear.

4. The rotary position sensor according to claim 1 characterized in that the gear box provides at least two rotating ring gears each of which carries at least one of the at least one target.
